(19) United States
(12) Patent Application Publication
(10) Pub. No.: US 2025/0384497 A1
(43) Pub. Date: Dec. 18, 2025

(54) ARTIFICIAL INTELLIGENCE-POWERED BUILDING INSPECTION SYSTEM

(71) Applicant: State Farm Mutual Automobile Insurance Company, Bloomington, IL (US)

(72) Inventors: John Hurliman, Bloomington, IL (US); Aaron Williams, Bloomington, IL (US)

(73) Assignee: State Farm Mutual Automobile Insurance Company, Bloomington, IL (US)

(21) Appl. No.: 18/779,945

(22) Filed: Jul. 22, 2024

Related U.S. Application Data
(60) Provisional application No. 63/659,245, filed on Jun. 12, 2024.

(51) Int. Cl. G06Q 50/16; G06Q 30/018

(52) U.S. Cl. CPC G06Q 50/16; G06Q 30/018

(57) ABSTRACT

A building inspection system for generating a structured building inspection report for at least a portion of a residential building may (1) receive building data for the residential building from one or more data sources, wherein the building data includes structural information about the at least a portion of the residential building; (2) determine a layout for the at least a portion of the residential building based upon the structural information; (3) generate a guided building assessment plan on a user device based upon the building data, wherein the guided building assessment plan provides inspection instructions for a user to gather unstructured user observations of the at least a portion of the residential building; (4) receive the unstructured user observations; and (5) automatically generate, using an artificial intelligence model, the structured building inspection report in a predetermined format for delivery to one or more users associated with the residential building based upon the building data and the unstructured user observations.

### FIELD OF THE INVENTION

The present disclosure generally relates to building inspection systems. More particularly, the present systems and methods relate to using an artificial intelligence powered building inspection system which is configured to guide a user through an inspection process and generate an inspection report.

### BACKGROUND

Buildings may be inspected to determine the state of a building or a building component of the building including determining any faults or problems with the building at times of sale or transfer, time of obtaining insurance, or at any other times when users associated with the building may want to inspect the building. Building inspections may be expensive and time consuming for building owners, building managers, or prospective building owners.

Therefore, in many cases building inspections may be skipped given the cost and time necessary to conduct them. Conventional techniques may include additional ineffectiveness, inefficiencies, encumbrances, and drawbacks as well.

### BRIEF SUMMARY

A building inspection system may be provided that generates a structured building inspection report for at least a portion of a residential building, such as to facilitate (1) receiving building data for the residential building from one or more data sources, wherein the building data includes structural information about the at least a portion of the residential building; (2) determining a layout for the at least a portion of the residential building based upon the structural information; (3) generating a guided building assessment plan on a user device based upon the building data, wherein the guided building assessment plan provides inspection instructions for a user to gather unstructured user observations of the at least a portion of the residential building; (4) receiving the unstructured user observations; and/or (5) automatically generating, using an artificial intelligence model, the structured building inspection report in a predetermined format for delivery to one or more users associated with the residential building based upon the building data and the unstructured user observations.

In one aspect, an inspection computer system for generating a structured building inspection report may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. In some implementations, the one or more AI models may include a generative AI model. Additionally or alternatively, the one or more AI models may include a computer vision model. In some implementations, the structured building inspection report may include a plurality of building faults. Instructions stored on non-transitory computer readable media may cause or direct the one or more processors to automatically generate the structured building inspection report by determining priorities for the plurality of building faults and/or order the plurality of building faults within the structured building inspection report using the determined priorities. In certain embodiments, the functionality and/or operations may include generating a maintenance plan for the building based upon the structured building inspection report. The computer system may include additional, less, or alternate functionality, including that disclosed elsewhere herein.

In another aspect, a computer-implemented method for generating a structured building inspection report for at least a portion of a building may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the computer-implemented method may include, such as via one or more local or remote processors, transceivers, sensors, other electronic components (including those discussed elsewhere herein), and/or computer-readable storage media having instructions stored thereon executable by the processors, transceivers, sensors, and/or other electronic components: (1) receiving, by one or more processors, building data for a building from one or more data sources, wherein the building data includes structural information about the at least a portion of the building; (2) determining, by the one or more processors, a layout for at least a portion of the building based upon the structural information; (3) generating, by the one or more processors, a guided building assessment plan on a user device based upon the building data, wherein the guided building assessment plan provides inspection instructions for a user to gather unstructured user observations of the at least portion of the residential building; (4) receiving the unstructured user observations; and/or (5) automatically generating, by the one or more processors and using an artificial intelligence model, the structured building inspection report in a predetermined format for delivery to one or more users associated with the building based upon the building data and the unstructured user observations. The method may include additional, less, or alternate functionality, including that discussed elsewhere herein.

In some implementations, one or more data sources include at least one of a connected devices data source configured to provide data regarding one or more data source, a user device data source configured to provide data regarding a user device, a provider data source configured to provide data regarding a provider, a third party data source configured to provide data from one or more third parties, or an integrated software data source configured to provide data regarding integrated software associated with the building. In some implementations, the user device is at least one of a smart mobile device, a smart ring, a wearable, smart glasses, a virtual reality device, or an augmented reality device. In some implementations, the guided building assessment plan is at least one of a room-by-room guided building assessment plan or a component-by-component guided building assessment plan. In some implementations, the inspection instructions may include requesting at least one of images, natural language written observations, or natural language speech observations. In some implementations, the structured building inspection report may include a plurality of building faults. The instructions may cause the one or more processors to automatically generate the structured building inspection report by determining priorities for the plurality of building faults and order the plurality of building faults within the structured building inspection report using the determined priorities.

For instance, the computer-implemented method may include, such as via one or more processors and/or other electronic components, (i) receiving, by the one or more processors, a first unstructured user observation from the user via a conversational chat bot associated with a large language model; (ii) generating, by the one or more processors and using the large language model, a follow-up prompt requesting additional information about the first unstructured user observation; (iii) in response to receiving the follow-up prompt, receiving, by the one or more processors, a second unstructured user observation providing the additional information; and/or (iv) processing, by the one or more processors and using one or more artificial intelligence (AI) models, the first unstructured user observation and the second unstructured user observation to generate the structured building inspection report. In another instance, the computer-implemented method may include, such as via one or more processors and/or other electronic components generating, by the one or more processors, a maintenance plan for the building based upon the structured building inspection report.

In some implementations, the computer-implemented method may include, such as via one or more processors and/or other electronic components, (i) receiving audiovisual data associated with at least one travel event of a user; and/or (ii) selecting the recommended transportation modality option using the audiovisual data. Additionally or alternatively, the computer-implemented method may include, such as via one or more processors and/or other electronic components, including those discussed elsewhere herein, (i) receiving travel data including geolocation information of a user as the user travels between the first geographic location and the second geographic location; and/or (ii) comparing and analyzing the travel data with historical travel data associated with the recommended transportation modality option to verify the recommended transportation modality option.

In another aspect, a non-transitory computer readable medium having instructions stored thereon that, when executed by one or more processors, cause the one or more processors to perform various functionality and operations. For instance, the functionality and operations may include or direct (1) receiving one or more unstructured user observations from a user regarding at least one of a component or a space of a residential building; (2) processing, using one or more artificial intelligence (AI) models, the one or more unstructured user observations to identify one or more additional data items regarding the at least one of the component or the space; (3) obtaining the one or more additional data items; (4) determining, by the one or more AI models using the one or more unstructured user observations and the one or more additional data items, a building fault associated with the at least one of the component or the space of the residential building and a type of repair to resolve the building fault; and/or (5) initiating, using the one or more AI models, an automatic action to resolve the building fault based upon the determined type of repair. The instructions may direct additional, less, or alternate functionality and/or operations, including that discussed elsewhere herein.

For instance, in some implementations, the functionality and operations may include (i) in response to determining the type of repair is a non-professional repair, automatically generating step-by-step instructions for a non-professional user to resolve the building fault; and/or (ii) in response to determining the type of repair is a professional repair, automatically scheduling a service appoint for professional maintenance personnel to resolve the building fault.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a first block diagram of an exemplary artificial intelligence assisted inspection computer system, according to some embodiments.

FIG. 2 is a second block diagram of the exemplary artificial intelligence assisted inspection computer system, according to some implementations.

FIG. 3 is a block diagram of exemplary reference data sources used by the artificial intelligence assisted inspection computer system, according to some embodiments.

FIG. 4 is a flow diagram of an exemplary computer-implemented or computer-based process for generating a building inspection report for a building, according to some implementations.

FIG. 5 is a flow diagram of an exemplary computer-implemented or computer-based process for fault detection and repair recommendation generation, according to some embodiments.

FIG. 6 is a flow diagram of an exemplary computer-implemented or computer-based process for generating a building inspection report for a building and automatically determining and automatically resolving building faults based upon the building inspection report, according to some implementations.

FIG. 7 is a flow diagram of an exemplary use case for resolving building faults based upon the building inspection report, according to some embodiments.

FIG. 8 is a flow diagram of another exemplary use case for resolving building faults based upon the building inspection report, according to some implementations.

FIG. 9 is a block diagram of exemplary reference data sources used by the artificial intelligence assisted inspection system and an exemplary computer-implemented or computer-based process for fault detection and repair recommendation generation, according to some embodiments.

FIG. 10 is a block diagram of exemplary reference data sources used by the artificial intelligence assisted inspection system and exemplary use cases for resolving building faults based upon the building inspection report, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, a building inspection system that generates a structured building inspection report for at least a portion of a building. For instance, a user may provide one or more observation and/or images regarding the building. Further, the building inspection system, may collect data from a variety of different sources (e.g., third-party sources, connected devices data sources, etc.) and generates a structured building inspection report based upon the collected data. In some embodiments, one or more AI models may be used by the building inspection system 102 to generate the building inspection report as will be explained in more detail below. In some implementations, the building inspection system may generate a repair recommendation for any building faults which are discovered why the building inspection report is being generated. A user interface may be presented to user, such as on a user mobile device, AR glasses, VR headset, wearables, smart rings, smart glasses, or other computing devices, displaying the structured building inspection report and/or any associated repair recommendations.

### Overview

Referring to the Figures, computer systems and computer-implemented methods for generating and/or providing a structured building inspection report may be provided. Particularly, the computer systems and computer-implemented methods may include an AI-assisted application which is configured to guide a user through a guided inspection of a building. Through the guided inspection, the user may provide personal observations and/or image data for the building while following the guided inspection of the building. In various embodiments, the computer systems, including the AI-assisted application, may be configured to receive data from one or more other data sources including, but not limited to, a connected devices data source, a user device data source, a provider data source, a third-party data source, or an integrated software data source. For example, the computer system may be configured to receive a transportation request and identify a first and a second location based upon the transportation request.

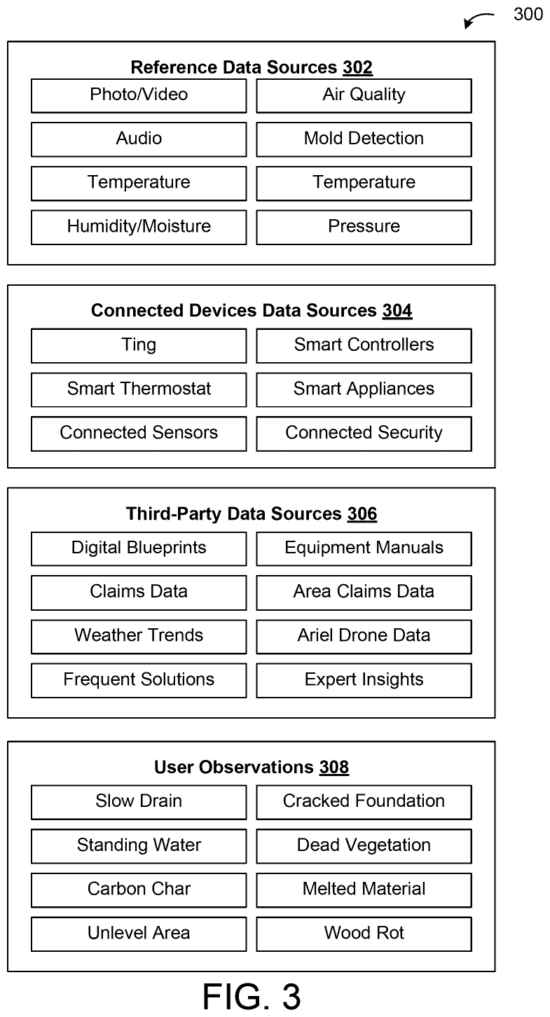

The systems and methods described herein would provide structured building inspection report similar to a professional inspection report, but would also include unique data from additional sources collected by an insurance provider such as past claims, neighborhood crime statistics, aerial image information, etc. The additional data sources are described in more detail with respect to FIG. 3 below. In various embodiments, the systems and methods described herein may provide potential home buyers the capability to conduct an inspection of the building any time in buying process (e.g., pre-offer, etc.). In other embodiments, the systems and methods described herein may provide potential home sellers to capability to assess and prepare a property prior to putting the building on the market. Further, in some embodiments, the systems and methods described herein may allow renters and landlords to assess the state of a building or one or more components of the building before and after a lease of the building. By allowing non-professional users to conduct a guided home inspection, the systems and methods described herein save time, resources, and costs.

The systems and methods described herein provide a number of benefits including: (1) providing expertise for non-professional users to conduct an inspection of the building where the expertise is provided by one or more trained AI models; (2) providing guidance on problematic areas or faults found in a building including generating instructions or recommendations on how to find parts and repair the fault; (3) creating a record over time of ongoing maintenance of a building (e.g., a building profile) that may be used for insurance claims, underwriting, and understanding the history of the building from a buyers or sellers point of view; and/or (4) creating an owner profile of owners or those who occupied the building which could provide a historical record of how they maintain the home/building they own, rent, or otherwise occupy.

Using the plurality of routes and/or the plurality of transportation modality options, a sustainability impact score may be generated for each of the routes, transportation modalities, and/or combinations thereof. The sustainability impact score may indicate an estimated climate impact of traveling along each of the routes and/or using the associated transportation modality (or combinations thereof). Using the sustainability impact scores, a recommended route, a recommended transportation modality, and/or a combination thereof may be selected and provided via a user interface.

In some embodiments, the recommended route and/or transportation modality is/are selected based upon an associated impact score indicating a lowest estimated climate impact (e.g., relative to the estimated climate impact of the plurality of routes/modalities) and/or lowest estimated environmental impact. Advantageously, the systems and methods described herein may allow individuals to identify climate-conscious routes and/or transportation modalities, which may be used to reduce and/or limit the climate impact of traveling between certain locations (e.g., along certain routes) and/or using certain transportation modalities.

Advancements in transportation infrastructure have afforded individuals the ability to choose between various routes of travel and/or modes of transportation (or combinations of modes of transportation) when traveling between different locations. For example, an individual may decide to take a more efficient route (e.g., a freeway that avoids traffic associated with an accident or construction) using one of their single-occupant vehicles (e.g., a hybrid car, a gas-powered truck, etc.) to travel to work. Similarly, an individual may decide to take public transportation to work, for example by walking or biking, or taking a ride share service, to a public transportation station, and choosing a mode of public transportation (e.g., a bus, a train, a shuttle, etc.) to commute the rest of the way to work.

In addition to being interested in traveling efficiently between different locations, individuals are now becoming more interested in travel options that reduce their environmental footprint (e.g., carbon emissions, fuel consumption, energy consumption, pollution, fossil fuel usage) and/or offer safer travel options when traveling to certain locations. While an individual may currently be able to evaluate travel times associated with various travel roues and/or modes of transportation, it should be noted that different travel routes and/or types of transportation may have different sustainability impacts on our environment (e.g., carbon emissions, fuel consumption, resource consumption, etc.), the impacts of which are less visible to individuals. As such, it would be advantageous to have a computer system that allows an individual to evaluate the environmental impact of travel between locations along different routes and/or using different transportation modalities.

Advantageously, one aspect of the computer systems and computer-implemented methods described herein may allow individuals to identify climate-conscious routes and/or transportation modalities. For example, by assessing travel characteristics of a user or operator (e.g., a tendency to speed, a tendency to accelerate/decelerate quickly, fuel efficiency of their vehicle, fuel usage of their vehicle, pollution and/or other emissions caused by their vehicle, etc.) and/or travel situations (e.g., road construction, a lane closure, traffic due to an accident, weather conditions, traffic congestion due to time-of-day (rush hour) or year (holiday traffic), type of road, urban versus rural roads/travel, etc.), the computer systems and computer-implemented methods described herein may identify a recommended route that reduces/limits climate impact associated with traveling (e.g., identifying a fuel-efficient route, a route that reduces stops/starts or sitting in traffic, a route that avoids rush hour congestion, a route that avoids bad weather (rain, ice, snow, etc.), a route that avoids traffic lights, a route that avoids hills or up and down roads, etc.). As a result, individuals may be incentivized to use routes that reduce their environmental impact.

Similarly, by assessing available travel options or routes (e.g., walking or running via various sidewalks or trails; bicycling via various bike lanes, trails, or road shoulders; public transportation; ride share or shuttle services; e-scooters or mini-scooters; motorcycles; autonomous vehicles; electric vehicles; gasoline-based vehicles; hybrid vehicles; etc.) and/or travel situations (e.g., road construction; traffic due to an accident; delays/slowdowns due to inclement weather; congestion; rush hour time-of-day; etc.), the computer systems and computer-implemented methods described herein may identify a type of transportation (or combinations thereof) that reduce/limit negative climate impact associated with traveling (e.g., identifying an alternative mode of transportation, identifying a mode that is a multi-occupant mode of transportation, identifying a specific route and/or time-of-day to travel to reduce pollution or other climate impact, etc.).

As a result, individuals may be incentivized to use transportation options that reduce their environmental impact. Finally, by assessing and analyzing travel characteristics of a user or operator, available travel options, and/or travel scenarios, the computer systems and computer-implemented methods described herein may identify a specific combination of a travel route and a transportation type (or combinations thereof) that identify a transportation route/method that provides a lowest estimated (negative) climate impact (e.g., carbon emissions, fuel consumption, oil or gas spillage, pollution, road wear and tear, etc.) of traveling to a destination.

Advantageously, one aspect of the computer systems and computer-implemented methods described herein may allow individuals to identify safe routes and/or transportation modality options. For example, by assessing travel characteristics of a user or operator (e.g., a tendency to travel at a proper speed and/or otherwise obey the posted speed limit, a tendency to accelerate/decelerate as required, a tendency to travel at a reasonable following distance from other vehicles, a tendency to follow proper rules of the road and street signs, a tendency to obey stop signs, etc.), available travel options (e.g., walking or biking (such as on sidewalks, bike lanes or trails, road shoulders); public transportation; automobile; bus; scooters; taxi; plane; boat; etc.), and/or travel situations (e.g., road construction; traffic due to an accident; delays/slowdowns due to inclement weather; rush hour traffic; time-of-day or time-of-year; congestion; type of route (urban or rural; two lane road versus four lane highway, etc.); length of route; etc.), the computer systems and computer-implemented methods described herein may identify a route and/or transportation type (or combinations thereof) that limits/reduces potential risks to a user while traveling to a destination (e.g., risk of being in an accident, risk of getting injured, risk of getting stranded in inclement weather conditions, etc.).

Further, the computer systems and computer-implemented methods described herein may be configured to provide individuals with protective services (e.g., coverage, etc.) over various routes and/or transportation modalities, for example based upon an estimated climate impact and/or safety score of the associated route/modality, thereby providing individuals with increased coverage, reducing an individual's level of risk (e.g., injury or financial risk, etc.), and/or reducing an individual's resource consumption (e.g., financial resource consumption, etc.).

### Exemplary AI Assisted Inspection Computer System With Inspection System

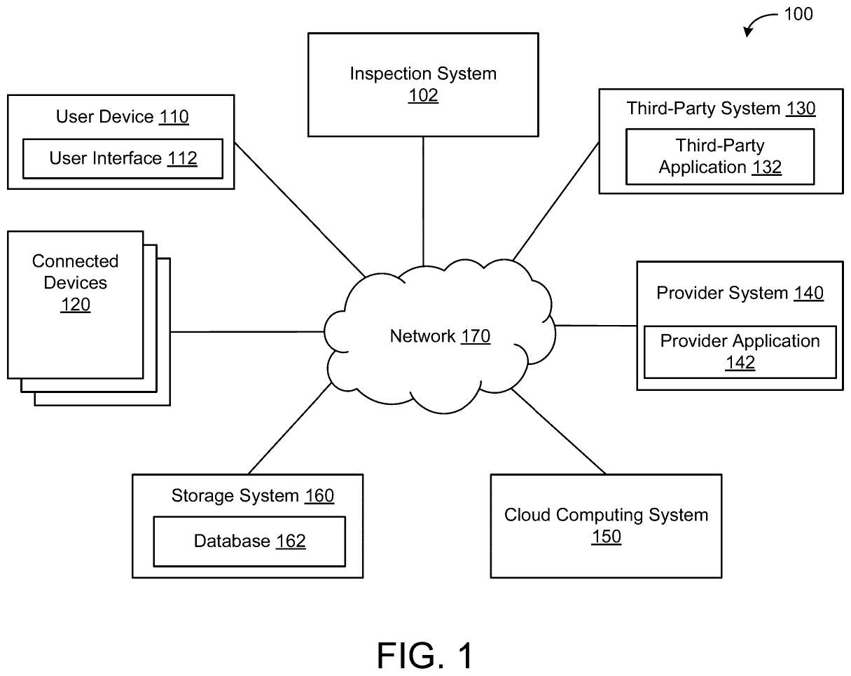

Referring to FIG. 1, a block diagram of an exemplary artificial intelligence (AI) assisted inspection computer system 100, is shown, according to some embodiments. The AI assisted inspection computer system 100 may include an inspection system 102, a user device 110 having a user interface 112, and at least one connected device, shown as connected devices 120. The AI assisted inspection computer system 100 may also include a third-party system 130 having a third-party application 132, a provider system 140 having a provider application 142, and a cloud computing system 150. The AI assisted inspection computer system 100 may also include a storage system 160 having a database 162. The components of the AI assisted inspection computer system 100 may be connected, or in wired or wireless communication, via a network 170. It should be noted that the number and type of components shown is merely illustrative and, in various embodiments, implementations of the AI assisted inspection computer system 100 may have additional, fewer, and/or different components than those illustrated in FIG. 1, including those mentioned elsewhere herein.

As will be discussed in greater detail below, the inspection system 102 may be configured to generate and/or provide (such as visually or audibly via one or more computing devices) a structured building inspection report for a building, or at least a portion of the building, using one or more artificial intelligence models. In some embodiments, the building may be residential type of a building such as a house, townhouse, condo, etc. In other embodiments, the building may be a commercial type of building. For example, the inspection system 102 may be configured to receive building data for the building from one or more data sources. Based upon the building data, the inspection system 102 may be configured to determine a layout for the building and generate a guided building assessment plan for the building which guides a user through conducting an inspection of the building. The guided building assessment plan may provide step-by-step inspection instructions which direct the user to provide observations about the building, collect images of the building, and provide any other data for the building which may be useful in generating the structured building inspection report. In certain embodiments, the guided building assessment plan is displayed on the user device 110.

In various embodiments, the inspection system 102 may receive user observations from a user device such as user device 110. The user observations may be provided in response to the guided building assessment plan. The inspection system 102 may be configured to automatically generate the structured building inspection report based upon the user observations and collected images of the building. Particularly, the inspection system 102 may utilize one or more artificial intelligence models to generate the structured building inspection report.

The inspection system 102 may process the user observations using one or more AI models to prompt the user to collect one or more additional data items. For example, if a user indicates through their observations that there are discolorations on a building ceiling, the AI models may generate a prompt requesting that the user move closer to the discolorations and capture additional data (e.g., images, more detailed observations, etc.) regarding the ceiling discoloration. In some embodiments, the AI models 210 may generate a prompt with follow up questions for the user. Particularly, the inspection system may receive a first user observation from a user via a conversational chat bot associated with a large language model.

The inspection system may then generate, by the large language model, a follow-up prompt requesting additional information about the first unstructured user observation. For example, returning to the ceiling discolorations, the prompt may ask the user how much of the ceiling is covered by the discoloration, what color is the discoloration, any liquid is leaking from the roof, etc. In certain implementations, the prompts may be generated using generative AI models. In response to receiving the follow-up prompt, the inspection system 102 may receive a second unstructured user observation providing the additional information requested. Finally, the inspection system 102 may process, by one or more AI models, the first unstructured user observation and the second unstructured user observation to generate at least a portion of the structured building inspection report.

The inspection system 102 may be configured to determine, based upon the initial user observations and/or the additional data, a building fault with a building component or a building space. Particularly, the inspection system 102 may determine the building fault using one or more AI models which are trained to recognize and categorize building faults using classification machine learning techniques. Further, the inspection system 102 may be configured to determine what type of repair may resolve the building fault and generate a repair recommendation.

In various embodiments, the repair recommendation may be based upon the building fault and type of repair determined. For example, if the type of repair is a non-professional type of repair (e.g., a common non-profession user may carry out the repair), the inspection system 102 may generate a repair recommendation that includes step-by-step instructions for a non-professional user to resolve the building fault.

As another example, if the type of repair is a professional type of repair (e.g., professional personnel need to may carry out the repair), the inspection system 102 may generate a repair recommendation that includes automatically scheduling a service appointment for the professional maintenance personnel to resolve the building fault. In both examples, the repair recommendation may also include generating a repair parts suggestions which prompts the user to order any service parts or tools needed to complete the repair.

In various embodiments, the inspection system 102 may be configured to generate a user interface providing the structured building inspection report to one or more users associated with the building. In certain implementations, the inspection system 102 may also generate a user interface providing the repair recommendation to one or more users associated with the building.

Referring still to FIG. 1, the inspection system 102 may be configured to communicate with components of the AI assisted inspection computer system 100. For example, information and/or data associated with the user device 110 and/or the connected devices 120 may be communicated to the inspection system 102 (e.g., via the network 170). Information and/or data associated with the third-party system 130 and/or the provider system 140 may also be communicated to the inspection system 102 (e.g., via the network 170). Information and/or data associated with the cloud computing system 150 and/or the storage system 160 may also be communicated to the inspection system 102 (e.g., via the network 170).

In various implementations, the inspection system 102 may be implemented using cloud computing services. The inspection system 102 may be implemented using one or more computing devices, for example operating alone and/or in combination. In some embodiments, the inspection system 102 may be implemented using computing architectures like multiple distributed servers, and/or similar computing devices and/or systems. In other embodiments, the inspection system 102 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the inspection system 102 may be configured to communicate with the user device 110. The user device 110 may include one or more human-machine interfaces or client interfaces, shown as user interface 112 (e.g., a graphical user interface, a text-based computer interface, a client-facing web service, a web service that provides pages to a web client, etc.), for example for controlling, viewing, and/or otherwise interfacing with the inspection system 102. The user device 110 may include a personal mobile computing device (e.g., a smart phone, a tablet, a mobile device, a wearable, smart glasses, a smart watch, etc.). Particularly, the user device 110 may include smart mobile device, a virtual reality device, or augmented device which is configured to display graphical user interfaces and capture data including images and user observations.

In various embodiments, information/data associated with the user device 110 may be communicated to the inspection system 102. The user device 110 itself may be configured to communicate information/data to the inspection system 102. In certain implementations, a device coupled to the user device 110, a component implemented with the user device 110, an application or program housed and/or executed on the user device 110, and/or another suitable component associated with the user device 110 may be configured to communicate information/data to the inspection system 102.

The inspection system 102 may be configured to receive user observation regarding a building from the user device 110. In various embodiments, the user observations may include any unstructured or natural language input from a user regarding the building. The user observations may include written observations in a natural language format. The user observations may include spoken observations in a natural language format. The user observations may also include any pictures or images captured by the user.

These user observations may be captured via various inputs into the user device 110. For example, the user device 110 may include a microphone or camera (e.g., for capturing audiovisual information such as the spoken observation). The user device 110 may capture (e.g., automatically, and/or in response to an input by a user or operator) audiovisual data around the user device 110, for example while a user or operator is following the guided building assessment plan. The user device 110 may communicate the audiovisual information to the inspection system 102. As another example, the user device 110 may include a keyboard or screen (e.g., for capturing written information such as the written observation).

As shown, information/data associated with the connected devices 120 may be communicated to the inspection system 102. The connected devices 120 may be any type of device connected, via some type of communications network (e.g., ethernet, WiFi, Bluetooth, etc.), with the building and configured to perform some sort of function within or for the building.

The connected devices 120 may be a type of smart device configured to automatically monitor and/or control a portion of the building. For example, the connected devices 120 may include smart controllers for controlling various portions of the building, smart thermostats for monitoring and managing the temperature with the building, smart appliances, connected home security, and/or one or more connected sensors for the building. The connected devices 120 may be configured to communicate information/data to the inspection system 102 about the building. For example, a smart thermostat may provide temperature data for the building which may be used by the inspection system 102 in generating the structured building inspection report. Each of the connected devices 120 may be configured to provide building information, including historical data, related to the connected device 120.

As shown, the inspection system 102 may be configured to receive information/data associated with the third-party system 130. In some implementations, the third-party system 130 may be a computing system for a third party associated with the building and configured to provide data relevant for generating a structured building inspection report. For example, the third-party system 130 may be a local weather source or a local news source configured to provide weather and crime data which may be used to generate a structured building inspection report. As another example, the third-party system 130 may be building maintenance or repair information source which is configured to provide information from relevant websites on how to identify and resolve building faults.

The third-party system 130 may include a third-party application 132. While the AI assisted inspection computer system 100 is shown to include one third-party system 130, it is contemplated herein that the AI assisted inspection computer system 100 may include a plurality of third-party systems 130. In various embodiments, the inspection system 102 may be configured to receive building and/or building related information/data from one or more the third-party systems 130. For example, the inspection system 102 may be configured to receive environmental (e.g., weather, etc.), social (e.g., crime, nearby traffic patterns, local noise levels, etc.), and/or ecological information associated with the third-party system 130.

As shown, information/data associated with the provider system 140 may be communicated to the inspection system 102. The provider system 140 may be configured to communicate information/data to the inspection system 102. In certain implementations, a device coupled to, a component implemented with the provider system 140, an application or program housed and/or executed on the provider system 140, and/or another suitable component associated with the provider system 140 may be configured to communicate information/data to the inspection system 102.

The provider system 140 may include a provider application 142. In some embodiments, the provider system 140 may be associated with a company or entity that provides protective services (e.g., insurance, etc.) to a user or owner of a building as identified by the user device 110 (e.g., a user or owner associated with the user device 110). The provider system 140 may include the inspection system 102, as described herein, in various implementations. In other embodiments, the provider system 140 and the inspection system 102 operate independently while data is shared between the two systems. In certain embodiments, the provider system 140 may be configured to communicate with the inspection system 102 (and/or the user device 110), for example, to generate and provide a structured building inspection report, identify any building faults, and provide repair recommendations for any building faults.

The inspection system 102 may be configured to receive insurance claim parameters provided by the provider system 140. Particularly, the provider system 140 may be configured to provide the insurance claim parameters to the various systems associated with the AI assisted inspection computer system 100 (e.g., to the inspection system 102, to the user device 110, etc.). An insurance claim parameter may refer to a parameter of one or more insurance claims associated with buildings. For example, the insurance claim parameter may include claim data for a state, claim data for a locality (e.g., county, city, neighborhood, etc.), claim data for a house type, and/or claim data for a particular address.

As noted herein, in certain embodiments the inspection system 102 may be configured to receive one or more insurance claim parameters associated with the building. The inspection system 102 may be configured to generate the structured building inspection report based upon, at least in part, the insurance claim parameters received from the provider system 140. For example, based upon the insurance claim parameters, the inspection system 102 may generate prompts for a user to provide specific user observations related to the insurance claim parameters. For example, if an insurance claim parameter indicates that buildings is located in a locality where the buildings are prone to water damage due to flooding, the inspection system 102 may generate the guided building assessment plan to focus on capturing user observations which may provide more detail on any potential water damage for the building.

As shown, the inspection system 102 may be configured to communicate with the cloud computing system 150. The cloud computing system 150 may be a cloud-based computing system, for example to provide digital connections between different computing devices and/or systems (e.g., as described herein). The cloud computing system 150 may be a virtual reality (VR) system or augmented reality (AR) system (or other computing device, such as mobile device, wearable, smart glasses, smart ring, laptop, etc.), for example to provide digital connections between a plurality of metadata sources, where the metadata sources are integrated within the VR system or AR system.

In various embodiments, the cloud computing system 150 may be implemented using one or more computing devices, for example, operating alone and/or in combination. The cloud computing system 150 may be implemented using computing architectures like multiple distributed servers, and/or similar computing devices and/or systems. In some embodiments, the cloud computing system 150 may be a server (e.g., including a processor coupled to a memory), for example to store and/or recall data and applications within the memory. In other embodiments, the cloud computing system 150 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the inspection system 102 may be configured to communicate with the storage system 160 (e.g., having the database 162). In some implementations, the inspection system 102 communicates with the storage system 160, either directly (e.g., via the network 170) or indirectly (e.g., via the user device 110, the connected devices 120, etc.). The storage system 160 may include one or more devices (e.g., RAM, ROM, Flash memory, hard disk storage, etc.) for storing data and/or computer code for implementing and/or facilitating the various processes, layers, and/or circuits described herein. The storage system 160 may be or include volatile memory or non-volatile memory, and may include database components, object code components, script components, and/or any other type of information structure for supporting the various activities and information structures described herein.

In certain embodiments, and as will be discussed in greater detail, the inspection system 102 may also be configured to generate data. For example, the inspection system 102 may include components that obtain, analyze, process, generate, store, and/or communicate data. In various embodiments, the inspection system 102 may be configured to generate and/or provide a structured building inspection report and any repair recommendations for a building based upon identified building faults.

### Exemplary Inspection Computer System

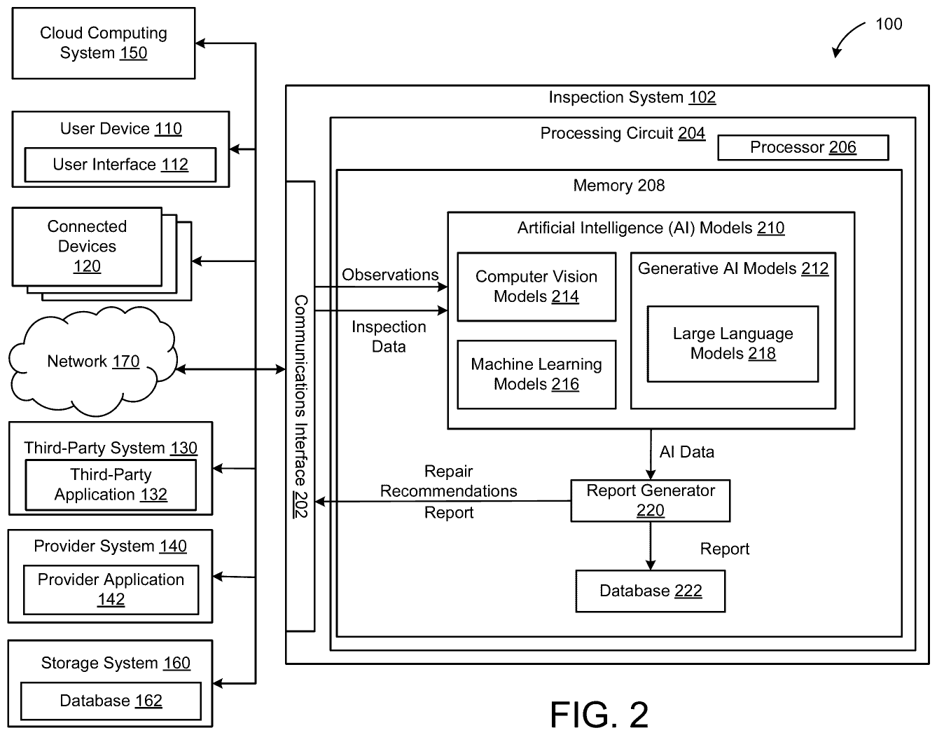

Referring now to FIG. 2, a block diagram of the exemplary inspection system, e.g., the inspection system 102, is shown in greater detail, according to some embodiments. As discussed above, the inspection system 102 may be configured to generate and/or provide a structured building inspection report for a building, or at least a portion of the building, using one or more artificial intelligence models.

The inspection system 102 may process the user observations using the one or more AI models 210 to prompt the user to collect one or more additional data items. In various embodiments, the AI models 210 may generate a prompt with follow up questions for the user. In various embodiments, the prompts may be generated using generative AI models such as generative AI models 212.

The inspection system 102 may be configured to determine, based upon the initial user observations and/or the additional data, a building fault with a building component or a building space. Particularly, the inspection system 102 may determine the building fault using the one or more AI models 210 which are trained to recognize and categorize building faults using classification machine learning techniques. Further, the inspection system 102 may be configured to determine what type of repair may resolve the building fault and generate a repair recommendation.

As shown in FIG. 2, the inspection system 102 may be communicably connected to the user device 110, the connected devices 120, the third-party system 130, the provider system 140, the cloud computing system 150, and the storage system 160 (e.g., via the network 170). In various embodiments, the inspection system 102 may be communicably connected to other suitable systems and/or devices (e.g., via the network 170), including those devices mentioned elsewhere herein. It should be understood that some or all of the components of the inspection system 102, the user device 110, the connected devices 120, the third-party system 130, the provider system 140, the cloud computing system 150, the storage system 160, and/or the network 170 may be implemented as part of a cloud-based computing system configured to obtain, process, and/or communicate data from one or more external devices or sources.

Similarly, some, or all, of the components of the inspection system 102, the user device 110, the connected devices 120, the third-party system 130, the provider system 140, the cloud computing system 150, the storage system 160, and/or the network 170 may be integrated within a single device or be distributed across multiple separate systems or devices. In some embodiments, inspection system 102, the user device 110, the connected devices 120, the third-party system 130, the provider system 140, the cloud computing system 150, the storage system 160, and/or the network 170 are components of a controller, a device controller, a field controller, a computer work station, a client device, and/or another system or device that receives, processes, and/or communicates data from/to devices or other data sources.

As shown, the inspection system 102 may include a communications interface 202 and a processing circuit 204 having a processor 206 and a memory 208. The communications interface 202 may include wired or wireless communications interfaces (e.g., jacks, antennas, transmitters, receivers, transceivers, wire terminals, etc.) for communicating data between the inspection system 102 and external systems or devices (e.g., the user device 110, the connected devices 120, the third-party system 130, the provider system 140, the cloud computing system 150, the storage system 160, etc.). In various implementations, the communications interface 202 facilitates communications between the inspection system 102 and one or more external applications and/or interfaces (e.g., the user interface 112, the third-party application 132, the provider application 142, etc.), for example to allow a remote user or operator to control, monitor, and/or adjust components of the inspection system 102.

Further, the communications interface 202 may be configured to communicate with external systems and/or devices using any of a variety of communications protocols (e.g., HTTP(S), WebSocket, CoAP, MQTT, etc.) and/or any of a variety of other protocols. Advantageously, the inspection system 102 may obtain, ingest, and process data from any type of system or device, regardless of the communications protocol used by the system or device.

As shown, the inspection system 102 may include the processing circuit 204 having the processor 206 and the memory 208. While shown as single components, it should be appreciated that the inspection system 102 may include one or more processing circuits, including one or more processors and memory.

In various embodiments, the inspection system 102 may include a plurality of processors, memories, interfaces, and/or other components distributed across multiple devices or systems, which are communicably coupled via a network (e.g., the network 170). For example, in a cloud-based or distributed implementation, the inspection system 102 may include multiple discrete computing devices, each of which include a processor 206, memory 208, communications interface 202, and/or other components of the inspection system 102. Tasks performed by the inspection system 102 may be distributed across multiple systems or devices, which may be located within a single building or facility or distributed across multiple buildings or facilities. In other embodiments, the inspection system 102 itself may be implemented within a single computer (e.g., one server, one housing, etc.). All such implementations are contemplated herein.

The processor 206 may be a general purpose or specific purpose processor, an application specific integrated circuit (ASIC), one or more field programmable gate arrays (FPGAs), a group of processing components, or other suitable processing components. The processor 206 may further be configured to execute computer code or instructions stored in the memory 208 or received from other computer readable media (e.g., USB or other local storage, network storage, a remote server, etc.).

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. The memory 208 may include database components, object code components, script components, and/or any other type of information structure for supporting the various activities and information structures described in the present disclosure. The memory 208 may be communicably connected to the processor 206 via the processing circuit 204, and may include computer code for executing (e.g., by the processor 206) one or more processes described herein. When the processor 206 executes instructions stored in the memory 208, the processor 206 may configure the processing circuit 204 to complete such activities.

As shown, the inspection system 102 (e.g., the memory 208) may include AI models 210, a report generator 220, and a database 222. The following paragraphs describe some of the general functions performed by each of the components 210-222 of the inspection system 102. It should be noted that the number and type of components shown is merely illustrative and, in some embodiments, implementations of the inspection system 102 may have additional, fewer, and/or different components than those illustrated in FIG. 2.

In some embodiments, the inspection system 102 utilizes the AI models 210 to analyze inspection data and user observations to generate a structured building inspection report. For example, the inspection system 102 may be configured to receive building data for the building from one or more data sources. Based upon the building data, the inspection system 102 may be configured to determine a layout for the building and generate a guided building assessment plan for the building which guides a user through conducting an inspection of the building. The guided building assessment plan may provide step-by-step inspection instructions which direct the user to collect and provide observations about the building, collect images of the building, and provide any other inspection data for the building which may be useful in generating the structured building inspection report. The inspection system 102 may receive user observations from a user device such as user device 110. The inspection system 102 may be configured to automatically generate the structured building inspection report based upon the user observations and collected images of the building. Particularly, the inspection system 102 may utilize one or more AI models 210 to generate the structured building inspection report.

The AI models 210 may include generative AI models 212. The generative AI models 212 may include one or more neural networks, including neural networks configured as generative models. For example, the generative AI models 212 may predict or generate data (e.g., the building layout, the guided building assessment plan, the structured building inspection report, building fault data, repair recommendation data, etc.) based upon the user observations and inspection data received by the inspection system 102.

The generative AI models 212 may generate any of a variety of modalities of data, such as text, speech, audio, images, and/or video data. For example, the structured building inspection report may be a combination of any of a text, audio, images, and/or video data which describes the state of a building or a building component.

In some implementations, the generative AI models 212 may include and use one or more neural networks to analyze the input data and generate output data such as the structured building inspection report. The neural network may include a plurality of nodes, which may be arranged in layers for providing outputs of one or more nodes of one layer as inputs to one or more nodes of another layer. The neural network may include one or more input layers, one or more hidden layers, and one or more output layers. Each node may include or be associated with parameters such as weights, biases, and/or thresholds, representing how the node may perform computations to process inputs to generate outputs. The parameters of the nodes may be configured by various learning or training operations, such as unsupervised learning, weakly supervised learning, semi-supervised learning, or supervised learning.

In various embodiments, the generative AI models 212 may include, for example and without limitation, one or more language models 218, attention-based neural networks, transformer-based neural networks, generative pretrained transformer (GPT) models (e.g., GPT-3, GPT-3.5, GPT-4, etc.), bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the generative AI models 212 may include at least one GPT model. The GPT model may receive an input sequence, and may parse the input sequence to determine a sequence of tokens (e.g., words or other semantic units of the input sequence, such as by using Byte Pair Encoding tokenization). The GPT model may include or be coupled with a vocabulary of tokens, which may be represented as a one-hot encoding vector, where each token of the vocabulary has a corresponding index in the encoding vector; as such, the GPT model may convert the input sequence into a modified input sequence, such as by applying an embedding matrix to the token, tokens of the input sequence (e.g., using a neural network embedding function), and/or applying positional encoding (e.g., sin-cosine positional encoding) to the tokens of the input sequence.

The GPT model may process the modified input sequence to determine a next token in the sequence (e.g., to append to the end of the sequence), such as by determining probability scores indicating the likelihood of one or more candidate tokens being the next token and selecting the next token according to the probability scores (e.g., selecting the candidate token having the highest probability scores as the next token). For example, the GPT model may apply various attention and/or transformer based upon operations or networks to the modified input sequence to identify relationships between tokens for detecting the next token to form the output sequence.

In certain embodiments, the generative AI models 212 may include at least one diffusion model, which may be used to generate image and/or video data. For example, the diffusional model may include a denoising neural network and/or a denoising diffusion probabilistic model neural network. The denoising neural network may be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based upon comparing the modified noised data with the training data instances, and modifying the candidate denoising neural network according to the convergence condition (e.g., modifying weights and/or biases of one or more layers of the neural network). In some implementations, the generative AI models 212 includes a plurality of generative models, such as GPT and diffusion models, that may be trained separately or jointly to facilitate generating multi-modal outputs, such as technical documents (e.g., building repair and service guides) that include both text and image/video information.

In some implementations, the generative AI models 212 may be configured using various unsupervised and/or supervised training operations. The generative AI models 212 may be configured using training data from various domain-agnostic and/or domain-specific data sources, including but not limited to various forms of text, speech, audio, image, and/or video data, or various combinations thereof. The training data may include a plurality of training data elements (e.g., training data instances).

The AI models 210 may include computer vision models 214. The computer vision models 214 may be configured to receive building image data from one or more components of the AI assisted inspection computer system 100 (e.g., the user device 110, the connected devices 120, the third-party system 130, the provider system 140, the cloud computing system 150, the storage system 160, etc.) and generate data, such as the structured building inspection report, based upon analyzing the image data. The computer vision models 214 may include a machine learning models and/or neural network, such as a neural network configured to perform computer vision operations on the received building image data (e.g., pictures, videos, etc.). The computer vision models 214 may be used to detect one or more conditions in an image that indicate a state of a building or a building component. In some embodiments, a structured building inspection report may be generated based upon the conditions detected by the computer vision models 214.

The AI models 210 may include machine learning models 216. The machine learning models 216 may include a regression model (e.g., linear or logistic), a support vector machine (SVM), random forests, a Bayes network, or a clustering model (e.g., k-means clustering), a natural language processing (NLP) algorithm (e.g., such as information extraction (IE), named entity recognition (NER), relation extraction, etc.). In general, the models may have a set of inputs and a set of outputs. To apply, one or more processors (e.g., processor 206) may feed the set of inputs (e.g., user observations, inspection data, etc.) to the generative AI models 212 and may process the inputs in accordance with a set of weights of the generative AI models 212 to generate an output (e.g., the building layout, the guided building assessment plan, the structured building inspection report, building fault data, repair recommendation data, etc.).

The data produced by the AI models 210 may be provided to the report generator 220 which is configured to generate a structured building inspection report based upon the data. Particularly, the report generator 220 may be configured to obtain AI data, analyze and synthesize the AI data, and generate a structured building inspection report to be communicated to other components of the AI assisted inspection computer system 100. In some embodiments, the structured building inspection report may be stored in the database 222.

The inspection system 102 may also be configured to determine one or more building faults by utilizing the AI models 210. As described above, the inspection system 102 may process the user observations and inspection data using the AI models 210. The AI models 210 may determine that additional data may be helpful in determining a building fault and prompt the user to collect one or more additional data items. In some implementations, the AI models 210, such as the generative AI models 212 may generate a prompt with follow up questions for the user.

As described above, the inspection system 102 may be configured to determine, based upon the initial user observations and/or the additional data, a building fault with a building component or a building space using the AI models 210. In some implementations, the AI models 210 are trained to recognize and categorize building faults using classification machine learning techniques. Further, the inspection system 102 may be configured to determine what type of repair may resolve the building fault and generate a repair recommendation. The repair recommendation may be based upon the building fault and type of repair determined.

In various implementations, the report generator 220 may generate a repair recommendation that may include a user interface that provides the structured building inspection report and/or the repair recommendation, or otherwise audibly or visually presents the structured building inspection report and/or the repair recommendation, such as via a computing device, display screen, or voice bot.

### Exemplary Data Sources

Referring now to FIG. 3, a one or more data sources 300 which provide inspection data to the inspection system 102 is shown, according to some implementations. As described above, the inspection system 102 uses the data from the one or more data sources 300 to generate a structured building inspection report, determine any building faults, and generate repair recommendations to address the building faults. In certain embodiments, the one or more data sources 300 may include reference data sources 302, connected devices data sources 304, third-party data sources 306, and user observations 308.

In various embodiments, the reference data sources 302 may be provided by the user device 110 and/or any other devices capable of capturing data about the building. Particularly, the user device 110 may be configured to capture data regarding the building to provide the reference data sources 302. The reference data sources 302 may include building reference data including photo/video data, audio data, temperature data, humidity/moisture data, air quality data, mold detection data, temperature data, and pressure data.

The connected devices data sources 304 may be provided to the inspection system 102 from the connected devices 120 associated with the building. The connected devices 120 may be any type of device connected, via some type of communications network (e.g., ethernet, WiFi, Bluetooth, etc.), with the building and configured to perform some sort of function within or for the building.

In exemplary implementations, the connected devices 120 may be a type of smart device configured to automatically monitor and/or control a portion of the building. For example, the connected devices 120 may include smart controllers for controlling various portions of the building, smart thermostats for monitoring and managing the temperature with the building, smart appliances, connected home security, and/or one or more connected sensors for the building. In certain embodiments, the connected devices 120 may include Ting which is a fire prevention system configured to monitor a building's electrical network for faults that may lead to fires.

In some embodiments, the connected devices 120 may be configured to communicate information/data to the inspection system 102 about the building. For example, a smart thermostat may provide temperature data for the building which may be used by the inspection system 102 in generating the structured building inspection report. Each of the connected devices 120 may be configured to provide building information, including historical data, related to the connected devices 120.

The third-party data sources 306 may be provided to the inspection system 102 from the third-party system 130. The third-party data sources 306 may be configured to provide data to the inspection system 102. The third-party system 130 may include a third-party application 132. In some embodiments, the inspection system 102 may be configured to receive building and/or building related information/data from one or more third-party systems 130 to generate the third-party data sources 306. The third-party data sources 306 may include, for example, digital blueprints of the building, claims data for the building, weather trends, frequent solutions, equipment manuals, area claims data, aerial drone data, and/or building expert insights.

The user observations 308 may be provided to the inspection system 102. The user observations 308 may be provided from a user through the user device 110. In some embodiments, the user observations may include any unstructured or natural language input from a user regarding the building. The user observations may include written observations in a natural language format. The user observations may include spoken observations in a natural language format. The user observations may also include any pictures or images captured by the user.

These user observations may be captured via various inputs into the user device 110. For example, the user device 110 may include a microphone or camera (e.g., for capturing audiovisual information such as the spoken observation). The user device 110 may capture (e.g., automatically, and/or in response to an input by a user or operator) audiovisual data around the user device 110, for example while a user or operator is following the guided building assessment plan. The user device 110 may communicate the user observations 308 to the inspection system 102. As another example, the user device 110 may include a keyboard or screen (e.g., for capturing written information such as the written observation). The user observations 308 may include, for example, user observations directed towards slow draining plumbing, standing water, carbon char, unlevel area, cracked foundation, dead vegetation, melted material, and/or wood rot.

The one or more data sources 300 may be stored in any portion of the system. For example, the one or more data sources 300 may be stored and maintain by the storage system 160 in the database 162. In other implementations, the one or more data sources 300 may be stored, or at least partially stored, on the connected devices 120, the user device 110, the inspection system 102, the third-party system 130, the provider system 140, and/or the cloud computing system 150.

### Exemplary Inspection System & Functionality

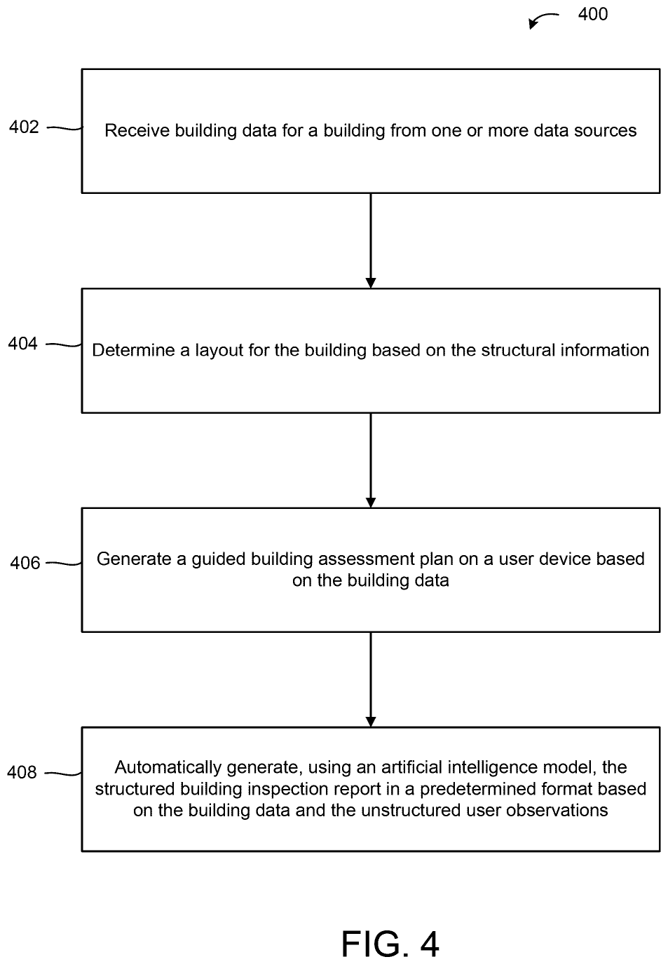

Referring now to FIG. 4, a computer-implemented or computer-based process, shown as process 400, for providing and/or generating a structured building inspection report is shown, according to some embodiments. Computer-implemented process 400 may be implemented by any and/or all the components of AI assisted inspection computer system 100 of FIGS. 1-2 (e.g., the inspection system 102, etc.). It should be appreciated that any and/or all the process 400 may be implemented by other systems, devices, and/or components (e.g., components of the AI assisted inspection computer system 100, the inspection system 102, etc.). Further, it should be appreciated that in various embodiments, process 400 may be implemented using additional, different, and/or fewer operations, actions, and/or functionality.

Computer-implemented process 400 may include receiving building data for a building from one or more data sources (block 402). The building data may be received from the one or more data sources 300 which are described in more detail above. The building data may include any data which describes the state and structure of the building. For example, the building data may include structural information for the building which may be obtained from building digital blueprints, building images, building electrical drawings, building plumbing drawings, etc.

In certain embodiments, a user may be prompted to enter the address of the building into a building inspection application (e.g., provider application 142). Based upon the address provided, the inspection system 102 may pull building data (e.g., building digital blueprints, building images, building electrical drawings, building plumbing drawings, etc.) relevant to that address from one or more third-party systems. In various implementations, the building data may also include insurance claim data associated with the address which is received from the provider system 140. In some embodiments, a user may be prompted to provide the building data (e.g., images, digital blueprints, insurance claim data, etc.) if the building data may not be obtained from third-party sources.

In some embodiments, the one or more data sources 300 may include a connected device data source configured to provide data regarding one or more connected devices, a user device data source configured to provide data regarding a user device, a provider data source configured to provide data regarding a provider, a third party data source configured to provide data from one or more third parties, and/or an integrated software data source configured to provide data regarding integrated software associated with the residential building. More details regarding the data sources 300 are provided above.

Computer-implemented process 400 may include determining a layout for the building based upon the structural information received at block 402, (block 404). In some embodiments, other building data may also be used, in conjunction with the structural information, to generate the layout for the building. For example, images of the building (e.g., aerial drone images, user provided images of the building, etc.) may be used in conjunction with the structural information to generate the layout for the building.

Computer-implemented process 400 may include generating a guided building assessment plan to display on a user device based upon the determined layout for the building (block 406). The guided building assessment plan may be provided on a user device to guide the user through an inspection of the building. Particularly, the guided building assessment plan provides inspection instructions for a user to gather unstructured user observations of the building or at least a portion of the building. The inspection instructions may include requesting at least one of the images, natural language written observations, or natural language speech observations.

In some implementations, the guided building assessment plan may be a room-by-room guided building assessment plan which guides the user to evaluate structural, mechanical, plumbing, electrical, and safety components of the building going room-by room. In other embodiments, the guided building assessment plan may be a component-by-component guided building assessment plan which guides the user to evaluate structural, mechanical, plumbing, electrical, and safety components of a building going component-by-component. In some embodiments, the guided building assessment plan may include step-by-step instructions for how to conduct an inspection of the building components.

In some embodiments, the structural components of the building may include, but are not limited to, exterior components, roofing, windows, flooring, foundation, walls, and ceilings. For structural components of the building, the guided building assessment plan may provide step-by-step instructions for inspecting the structural components and providing user observations. In some implementations, the instructions may begin by guiding the user through a visual inspection of the building. The guided building assessment plan may provide examples about what “normal” or non-faulty structural components should look and function (e.g., “stair rails should be firm not wiggly,” “windows should be able to be opened and closed with ease,” etc.).

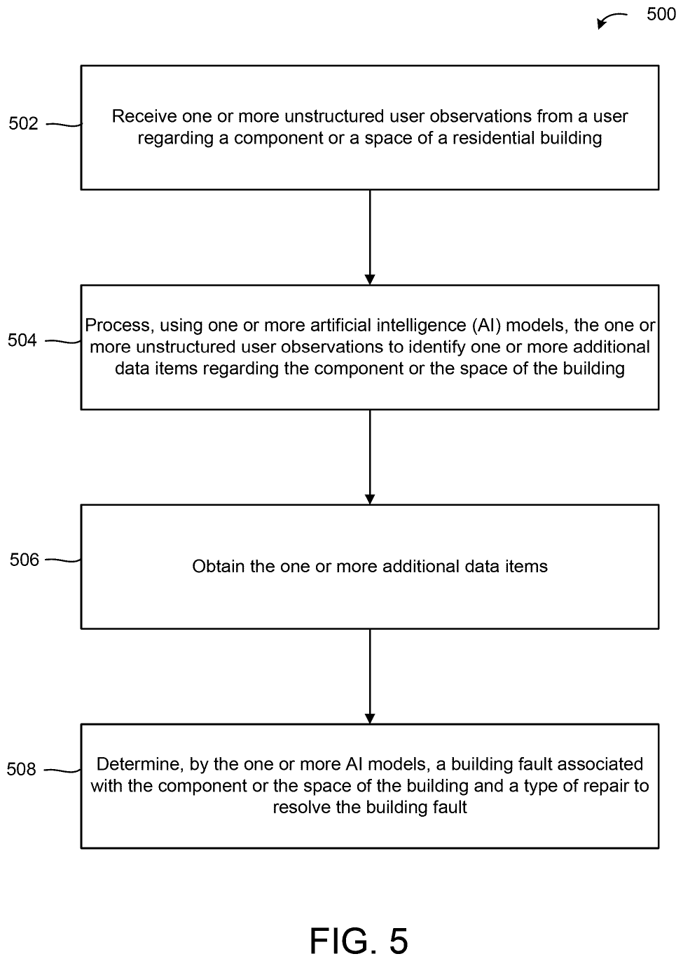

The guided building assessment plan may ask the user questions regarding the structural components. For example, the guided building assessment plan may ask if any of the structural components are cracked, broken, uneven, loose, stuck, discolored, or abnormal in any way. If the user indicates that any of the structural components are indeed abnormal, the guided building assessment plan would request that the user provide images of the abnormal structural component. Based upon the user provided images, the inspection system 102 may analyze the images using the AI models 210, to determine what fault is causing the abnormal structural component, the severity of the fault, and a recommendation to resolve the fault. The process for determining the recommendation is described in more detail below with regards to FIG. 5.

The mechanical components of the building may include, but are not limited to, building appliances and building devices. For mechanical components of the building, the guided building assessment plan may provide step-by-step instructions for inspecting the mechanical components and providing user observations.

In some embodiments, the instructions may begin by requesting that user provides an identifier (e.g., serial number, barcode, model number, etc.) for the mechanical component(s). Additionally or alternatively, the inspection system 102 may utilize the identifier to obtain information about the mechanical component. The information may include, but is not limited to, age of the mechanical component, estimated lifespan of the mechanical component, possible performance issues, and/or any recall information for the mechanical component. Based upon the information about the mechanical component, the guided building assessment plan will guide the user to take certain steps to test the function of the appliance. If the mechanical component fails any of the tests, the inspection system 102 may analyze the test data for the mechanical component to determine what fault is causing the failed test, the severity of the fault, and a recommendation to resolve the fault. The process for determining the recommendation is described in more detail below with regards to FIG. 5.

In some implementations, the plumbing components of the building may include, but are not limited to, plumbing fixtures, water supply system, sinks, bathtubs, showers, toilets, and/or pipe system. For plumbing components of the building, the guided building assessment plan may provide step-by-step instructions for inspecting the plumbing components and providing user observations. In certain embodiments, the instructions may begin by asking the user a series of questions to collect user observations about the plumbing system. The user observations may be used to determine the state of the plumbing components. For example, the questions may include, but are not limited to: (1) Does water flow freely and fully from the water source? (2) After a predetermined amount of time, does the drain back up at all? (3) Does the water overflow drain work properly? (4) Does the toilet flush and refill within a predetermined amount of time? If the user answers yes to any of these questions, the inspection system 102 may perform an analysis to determine a fault in the plumbing components and generate a recommendation to resolve the fault. The process for determining the recommendation is described in more detail below with regards to FIG. 5.

In various implementations, the electrical components of the building may include, but are not limited to, electrical fixtures, circuit breakers, wiring systems, and/or electrical outlets. For electrical components of the building, the guided building assessment plan may provide step-by-step instructions for inspecting the electrical components and providing user observations. In some embodiments, the instructions may begin by asking the user a series of questions to collect user observations about the electrical system.

The user observations may be used to determine the state of the electrical components. For example, the questions may include, but are not limited to: (1) Does all the outlets and switches have proper covers? (2) Do all the outlets and switches work? (3) May you tell what each switch controls? If the electrical components fail any of these tests, the inspection system 102 may perform an analysis to determine a fault in the electrical components and generate a recommendation to resolve the fault. The process for determining the recommendation is described in more detail below with regards to FIG. 5. In some implementations, connected devices 120, such as Ting, may be used to determine that state of the electrical components.

In various embodiments, the safety components of the building may include, but are not limited to, fire detectors, smoke alarms, security systems, carbon monoxide detectors, water sensors, and/or sprinkler systems. For safety components of the building, the guided building assessment plan would provide step-by-step instructions for inspecting the safety components and providing user observations. In some implementations, the instructions may begin by asking the user a series of questions to collect user observations about the electrical system.

The user observations may be used to determine the state of the safety components. For example, the questions may include, but are not limited to: (1) Are all the appropriate smoke alarms installed and do they work properly? (2) Are door/window sensors installed and do they function properly? (3) Are water sensors installed and do they function properly? (4) Are all the appropriate carbon monoxide sensors installed and do they function properly? (5) Are security systems installed and do they function properly? If the security components fail any of these tests, the inspection system 102 may perform an analysis to determine a fault in the security components and generate a recommendation to resolve the fault. The process for determining the recommendation is described in more detail below with regards to FIG. 5.

Computer-implemented process 400 may include automatically generating, using the AI models 210, the structured building inspection report based upon the received building data and the unstructured user observations (block 408). In some implementations, the structured building inspection report may be in a predetermined format. For example, in some embodiments, the structured building inspection report may include a section which details the comprehensive faults found in the building as well as recommendations on how to address the faults. Further, the structured building inspection report may include data from one or more third-party sources to supplement the user observations and building data. In some implementations, the structured building inspection report indicates which faults are the highest priority. Particularly, the inspection system 102 may be configured to determine priorities for the faults and order the faults within the structured building inspection report using the determined priorities.

In some embodiments, the inspection system 102 may be configured to generate a maintenance plan for the building based upon the building data, the user observations, and the determined building faults. The maintenance plan may indicate the level of effort that it would take for a user to maintain the building. In some implementations, the maintenance plan may include a cost estimate for the annual cost for home maintenance and repair for the building. In some embodiments, the structured building inspection report may include the maintenance plan.

The structured building inspection report may be provided to variety of associated parties who have an interest in the building. For example, the structured building inspection report may be provided to one or more potential buyers who are interested in purchasing the building.

As another example, the structured building inspection report may be provided to a provider with an underwriting with a financial interest in the building (e.g., mortgage lender, etc.). As yet another example, the structured building inspection report may be provided to a provider agent or the provider system 140 to be integrated into the services the provider provides for the building (e.g., insurance coverage, home security, connected home ecosystem, etc.). In some implementations, a provider may provide a customized quote for a service to the user (e.g., fire insurance quote, water insurance quote, security system quote, etc.) based upon the structured building inspection report and general home factors.

### Exemplary Fault Detection and Repair Recommendation Generation

Referring now to FIG. 5, a computer-implemented or computer-based process, shown as process 500, for determining faults in a building and generating repair recommendation to resolve the fault is shown, according to some embodiments. Computer-implemented process 500 may be implemented by any and/or all the components of AI assisted inspection computer system 100 of FIGS. 1-2 (e.g., the inspection system 102, etc.). It should be appreciated that any and/or all the process 500 may be implemented by other systems, devices, and/or components (e.g., components of the AI assisted inspection computer system 100, the inspection system 102, etc.). Further, it should be appreciated that in various embodiments, process 500 may be implemented using additional, different, and/or fewer operations, actions, and/or functionality.

Computer-implemented process 500 may include receiving one or more unstructured user observations from a user regarding a component or a space of a building (block 502). As described above, the user observations may be provided in response to the guided building assessment plan. The user observations may describe the state of the structural components, mechanical components, plumbing components, electrical components, and/or safety components.

In various embodiments, the inspection system 102 may be configured to receive user observation regarding a building from the user device 110. In various implementations, the user observations may include any unstructured or natural language input from a user regarding the building components. The user observations may include written observations in a natural language format. The user observations may include spoken observations in a natural language format. The user observations may also include any pictures or images captured by the user of the building.

Computer-implemented process 500 may include processing, using the AI models 210, the one or more unstructured user observations to identify or request one or more additional data items regarding the component or the space of the building (block 504). For example, the user observations may indicate that an issue has been raised by the user regarding the component or the space of the building. At block 504, the AI models 210 may identify and request the one or more additional data items to provide additional details regarding the component or the space of the building.

Computer-implemented process 500 may include obtaining the one or more additional data items (block 506). In some embodiments, the one or more additional data items may be obtained from a user in the form of additional user observations. The additional user observations may obtain from a user via the user device 110. In certain implementations, the one or more additional data items may be obtained from a provider via the provider application 142. In various embodiments, the one or more additional data items may be obtained from a third-party source via the third-party system 130.

Computer-implemented process 500 may include determining, using the AI models 210, a building fault associated with the component or the space of the building and a type of repair to resolve the building fault (block 508). The building fault may be determined based upon the one or more unstructured user observations and the additional data collected. In certain embodiments, the inspection system 102 may determine the building fault using one or more AI models 210 which are trained to recognize and categorize building faults using classification machine learning techniques. Further, the inspection system 102 may be configured to determine what type of repair may resolve the building fault and generate a repair recommendation.

In some implementations, the repair recommendation may be based upon the building fault and type of repair determined. For example, if the type of repair is a non-professional type of repair (e.g., a common non-profession user may carry out the repair), the inspection system 102 may generate a repair recommendation that includes step-by-step instructions for a non-professional user to resolve the building fault.

As another example, if the type of repair is a professional type of repair (e.g., professional personnel need to carry out the repair), the inspection system 102 may generate a repair recommendation that includes automatically scheduling a service appointment for the professional maintenance personnel to resolve the building fault. In both examples, the repair recommendation may also include generating a repair parts suggestions which prompts the user to order any service parts or tools needed to complete the repair.

### Additional Exemplary Inspection Report and Repair Recommendation Generation

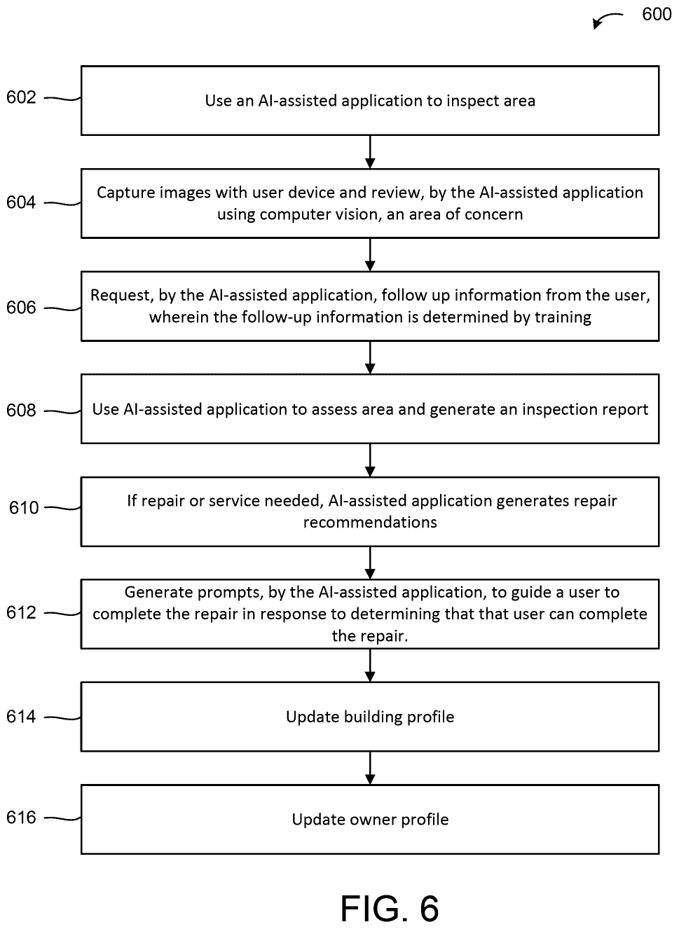

Referring now to FIG. 6, a computer-implemented or computer-based process, shown as process 600, for determining faults in a building and generating repair recommendation to resolve the fault is shown, according to some embodiments. Computer-implemented process 600 may be implemented by any and/or all the components of AI assisted inspection computer system 100 of FIGS. 1-2 (e.g., the inspection system 102, etc.). It should be appreciated that any and/or all the process 600 may be implemented by other systems, devices, and/or components (e.g., components of the AI assisted inspection computer system 100, the inspection system 102, etc.). Further, it should be appreciated that in various implementations, process 600 may be implemented using additional, different, and/or fewer operations, actions, and/or functionality.

Computer-implemented process 600 may include using an AI-assisted application to inspect an area of a building (block 602). As described above, a user may access the AI assisted application, such as the provider application 142, via the user device 110 to complete an inspection of a building. Particularly, the computer-implemented process 600 may include capturing images with the user device 110 which may be provided to the AI-assisted application (block 604).

Based upon the received images, the AI-assisted application may use computer vision to review an area of concern as captured by the images. For example, the inspection system 102 may facilitate using computer vision by the AI-assisted application by employing the computer vision models 214. The computer vision models 214 may include a machine learning models and/or neural network, such as a neural network configured to perform computer vision operations on the received captured images. The computer vision models 214 may be used to detect one or more conditions in an image that indicate a state of the inspected area. In some embodiments, a structured building inspection report may be generated based upon the analysis done by the computer vision models 214.

Computer-implemented process 600 may include requesting, by the AI-assisted application, follow-up information from the user (block 606). The follow-up information may request additional details (e.g., user observations, additional images, etc.) regarding the area inspected by the AI-assisted application at block 604. In various embodiments, the AI models 210 may be used to generate the request for follow up information. Particularly the AI models 210 may be trained to determine what additional information is needed to generate the structured building inspection report and generate a request for that information.

Based upon training, the AI models 210 may be configured to request specific data for certain buildings based upon data and historical information received about the building. For example, based upon weather data, the AI models 210 may determine that the building is located in area which commonly experiences extreme weather events like hailing, flooding, freezing, etc. Based upon this weather data, the AI models 210 may be trained to request specific and customized additional data which provides more detail about the building directed to components (e.g., siding, plumbing, etc.) which may be affected by the extreme weather events.

As another example, the AI models 210 may be configured to request specific data for certain building based upon when the building was built. For example, homes which were built during a certain time period may commonly have various faults. Based upon historical data indicating when the building was built, the AI models 210 may generate a follow-up requesting additional information which points the user to gather details about the components associated with common faults for building built during the time when the building was built.

Computer-implemented process 600 may include using the AI-assisted application to assess the area of the building and generate a structured building inspection report (block 608). More details regarding the process for generating the structured building inspection report are provided above with respect to FIG. 4.

In some implementations, the computer-implemented process 600 may optionally include determining if a repair or service is needed for any area or component evaluated by the AI-assisted application. If a repair or service is needed or recommended, the computer-implemented process 600 may include generating, using the AI-assisted application, generating a repair recommendation. The repair recommendation may include finding parts or service options for repairing any faults identified. In some implementations, the repair recommendation may include any pricing information associated with the parts or service options. In certain embodiments, the repair recommendation may include prompts that prompt a user to purchase parts and/or schedule a repair service.

Further, the computer-implemented process 600 may optionally determine what type of repair may resolve the building fault and generate a repair recommendation. In some implementations, the repair recommendation may be based upon the building fault and type of repair determined. For example, if the type of repair is a non-professional type of repair (e.g., a common non-profession user may carry out the repair), the computer-implemented process 600 may generate prompts to guide a user to complete the repair in response to determining that the non-professional user may complete the repair. The prompts may include step-by-step instructions for repairing the fault. As another example, if the type of repair is a professional type of repair (e.g., professional personnel need to carry out the repair), the repair recommendation that includes automatically scheduling a service appointment for the professional maintenance personnel to resolve the building fault.

Computer-implemented process 600 may include updating a building profile associated with the building inspection report which was generated (block 614). In some implementations, the building profile may include a history of the building including any previous building inspection reports previously conducted for the building, any faults and repairs conducted for the building, and any maintenance data for the building (e.g., how quickly were faults repaired in the building, how was the building maintained, general costs associated with the building, etc.). Computer-implemented process 600 may include updating an owner profile associated with the building inspection report which was generated (block 616), according to some embodiments.

In various embodiments, the owner profile may include a building owning history of the owner including any previous building owned by the owner, building inspection reports previously conducted for any buildings associated with the owner, any faults and repairs conducted for any buildings associated with the owner, and any maintenance data for the building (e.g., how quickly were faults repaired in the building, how was the building maintained, general costs associated with the building, etc.) associated with the owner.

In various implementations, the building profile and the owner profile may be provided to a variety of users associated with the building such as, but not limited to, potential buyers, underwriters, and insurance provider agents. These various users may consider the building profile when making decision regarding the building. For example, a provider may provide a customized quote for a service to the user (e.g., fire insurance quote, water insurance quote, security system quote, etc.) based, at least in part, on the owner and/or building profile.

### Exemplary Use Cases

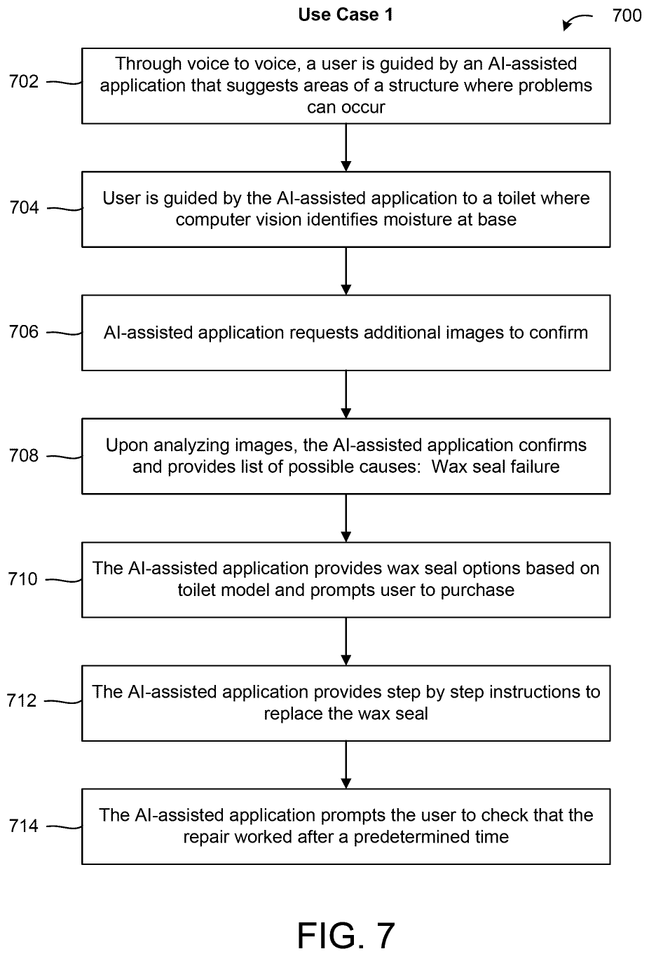

Referring now to FIG. 7, a computer-implemented or computer-based process, shown as process 700, detailing a first example use case for using the AI-assisted application to determine faults in a building and generating repair recommendation to resolve the fault is shown, according to some embodiments. Computer-implemented process 700 may be implemented by any and/or all the components of AI assisted inspection computer system 100 of FIGS. 1-2 (e.g., the inspection system 102, the provider application 142, etc.). It should be appreciated that any and/or all the process 700 may be implemented by other systems, devices, and/or components (e.g., components of the AI assisted inspection computer system 100, the inspection system 102, etc.). Further, it should be appreciated that in various implementations, process 700 may be implemented using additional, different, and/or fewer operations, actions, and/or functionality.

Computer-implemented process 700 may include using an AI-assisted application to guide a user through an inspection of a building (block 702). Particularly, in some examples, through voice-to-voice instructions, a user may be guided by the AI-assisted application to collect user observations and image data. The AI-assisted application may suggest areas of a building structure where problems may occur so that the user may collect user observations and data about those areas.

In the particular exemplary use case shown in FIG. 7, the user is guided by the AI-assisted application to a toilet (block 704). At the toilet, the AI-assisted application identifies moisture at the base of the toilet based upon the user observations and image data using computer vision models 214 (block 704). The computer vision models 214 are explained in more detail above. In some embodiments, the AI-assisted application requests additional images to confirm the identification made previously (block 706). Upon analyzing images, the AI-assisted application confirms and provides a list of possible causes of the identified moisture at the base of the toilet (block 708).

In some implementations, the list of possible causes is ordered by priority from most likely to be the cause to least likely to be the cause. In the particular exemplary use case shown in FIG. 7, the list of possible causes includes wax seal failure. Since only one possible cause is determined in this case, the AI-assisted application determines that the fault is wax seal failure. The AI-assisted application may provide step-by-step instructions on how to replace the wax seal (block 712) to repair the wax seal failure. In certain embodiments, the AI-assisted application may prompt the user to check that the repair worked after a predetermined time (block 714).

Computer-implemented process 800 may include using an AI-assisted application collecting user observations. Particularly, the user may observe that a smart furnace only runs for a short time and then turns off (block 802). The user provides the user observations to the AI-assisted application (block 804), according to some embodiments. The AI-assisted application may request data from the home's smart controller that is connected to the smart furnace (block 806). The smart furnace may share an error code that indicates a flame sensor failure may cause the smart furnace to only run for a short time and then turns off. The smart furnace may share the error code with the smart controller (block 808).

Additionally, the AI-assisted application may guide the user through repairing the flame sensor failure. Particularly, the AI-assisted application prompts the user with step-by-step visual indicators, through a user device such as a VR headset, on how to turn off the smart furnace, remove the cover, and locate the false sensor (block 810), according to some embodiments.

Further, the AI-assisted application then guides the user through removing, inspecting, and cleaning the flame sensor, testing the flame sensor, and completing the repair (block 812), according to some implementations. In some embodiments, the AI-assisted application may determine if further professional help is needed. For example, a user may indicate that they were not able to complete the repair. As another example, the AI-assisted application may request follow-up images and data to automatically determine whether the user was able to complete the repair. If the AI-assisted application determines that the user wasn't able to complete the repair and that professional help is needed, the AI-assisted application provides a list of qualified repair shops in the area (block 812), according to some embodiments.

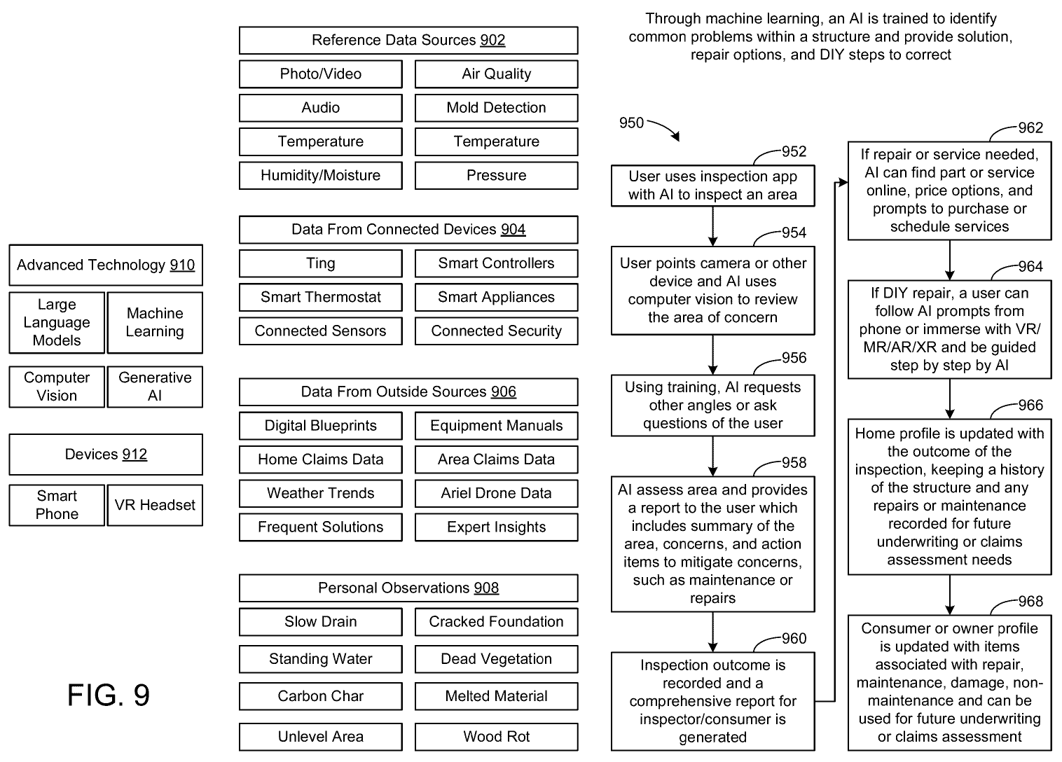

Referring now to FIG. 9, a block diagram of exemplary reference data sources used by the artificial intelligence assisted inspection system and an exemplary computer-implemented or computer-based process for fault detection and repair recommendation generation, according to some embodiments. A plurality of exemplary data sources are shown, according to some implementations. The exemplary data sources may include reference data sources 902, data from connected devices 904, data from outside sources 906, and/or personal observations 908. The exemplary data sources may be similar to the exemplary data sources 300 shown and described with respect to FIG. 3. For example, the reference data may be utilized by the inspection system 102 to generate a structured building inspection report, determine any building faults, and generate repair recommendations to address the building faults. In certain embodiments, plurality of data sources may include reference data sources 902, data from connected devices 904, data from outside sources 906, and personal observations 908.

In various embodiments, the reference data sources 902 may be provided by the user device 110 and/or any other devices capable of capturing data about the building. The reference data sources 902 may include building reference data including photo/video data, audio data, temperature data, humidity/moisture data, air quality data, mold detection data, temperature data, and pressure data.

The data from connected devices 904 may be provided to the inspection system 102 from the connected devices 120 associated with the building. The connected devices 120 may be any type of device connected, via some type of communications network (e.g., ethernet, WiFi, Bluetooth, etc.), with the building and configured to perform some sort of function within or for the building. The data from connected devices 904 may include data from, for example, Ting, a smart thermostat, connected sensors, smart controllers, smart appliances, and/or connected security devices.

The data from outside sources 906 may be provided to the inspection system 102 from the third-party system 130. The data from outside sources 906 may be configured to provide data to the inspection system 102. In some embodiments, the inspection system 102 may be configured to receive building and/or building related information/data from one or more third-party systems 130 to generate the data from outside sources 906. The data from outside sources 906 may include, for example, digital blueprints, claims data for a home, weather trends, frequent solutions, equipment manuals, area claims data, aerial drone data, and/or expert insights.

The personal observations 908 may be provided to the inspection system 102. The personal observations 908 may be provided from a user through the user device 110. The personal observations may include, for example, a slow drain, standing water, carbon char, an unlevel area, cracked foundation, dead vegetation, melted material, and/or wood rot.

Referring still to FIG. 9, a plurality of advanced technologies 910 are shown, according to some implementations. Advanced technology may include, for example, large language models, machine learning, computer vision, and/or generative artificial intelligence. The advanced technology 910 may be utilized to analyze inspection data and user observations to generate an inspection report, such as a structured building inspection report.

The advanced technology 910 described herein may be implemented on or using one or more devices 912. The device 912 may be or be similar to a user device 110. Devices 912 may be, for example, a smart phone and/or a VR headset.

FIG. 9 includes flow diagram of a computer-implemented or computer-based process, shown as process 950, detailing a first example use case for using the AI-assisted application to determine faults in a building and generating repair recommendation to resolve the fault. The process 950 may be similar to the process 600 of FIG. 6 described elsewhere herein.

An artificial intelligence model (e.g., one or more of the advanced technologies 910) may be trained to identify common problems within a structure (e.g., a building, a house, etc.) and generate or provide a solution, repair options, and or do-it-yourself (DIY) steps that a user may implement to address and/or solve the problems.

At block 952, a user may utilize an artificial intelligence-assisted inspection application to inspect an area (e.g., an area of a building experiencing a problem). At block 954, the user may point or direct a camera or other device towards the area experiencing the problem. The artificial intelligence model may use computer vision to review the area experiencing the problem. At block 956, the AI model, which, in some embodiments, has been previously trained, may request additional angles of the area. The AI model may additionally or alternatively ask questions to the user that may be relevant to determining a solution to the problem.

At block 958, the AI model may assess the area and provide a report to the user. The report may include a summary of the area, concerns of the area (e.g., problems that are occurring), and/or action items to mitigate the concerns. The action items may include, for example, maintenance to perform and/or repairs to make to resolve the concerns. At block 960, an outcome of the inspection performed by the AI is recorded. The AI model may generate a comprehensive report for a user (e.g., an inspector, a consumer, etc.). The comprehensive report may be similar to the report provided at block 958.

At block 962, responsive to a determination that a professional repair or service is needed (e.g., at block 958), the AI model may generate information for the user to perform the repair or schedule the service. For example, the AI model may determine that a specific part should be used to mitigate the problem, or a specific service should be scheduled to mitigate the problem. The AI model may generate information including a type of part and/or service needed to repair the problem, price options for the part and/or service, and prompts to the user to purchase the part and/or schedule the service.

At block 964, responsive to a determination that a DIY repair may be performed (e.g., at block 958), the AI model may generate a plurality of prompts instructing the user on how to repair the problem. The user may follow the AI-generated prompts from a user device (e.g., a device 912). For example, the user may view the prompts on a smartphone. In some embodiments, the user may utilize virtual reality (VR), mixed reality (MR), augmented reality (AR), and/or extended reality (XR) and be guided, step by step, by the AI model, to perform the repairs.

At block 966, responsive to either scheduling a repair and purchasing a replacement part or performing a DIY repair, a home profile of the building or structure may be updated with an outcome of the inspection. For example, the home profile may indicate that the user has performed a DIY repair and may include the repair steps taken by the user. The updated home profile may include a history of the structure being repaired and/or any previous repairs or maintenance. The maintenance history may be utilized for future underwriting and/or claims assessments.

At block 968, a profile of the user may be updated to include, for example, items associated with the repair, maintenance history, current or previous damage, and/or non-maintenance history. The information stored in the user profile may be utilized in future underwriting and/or claims assessment.

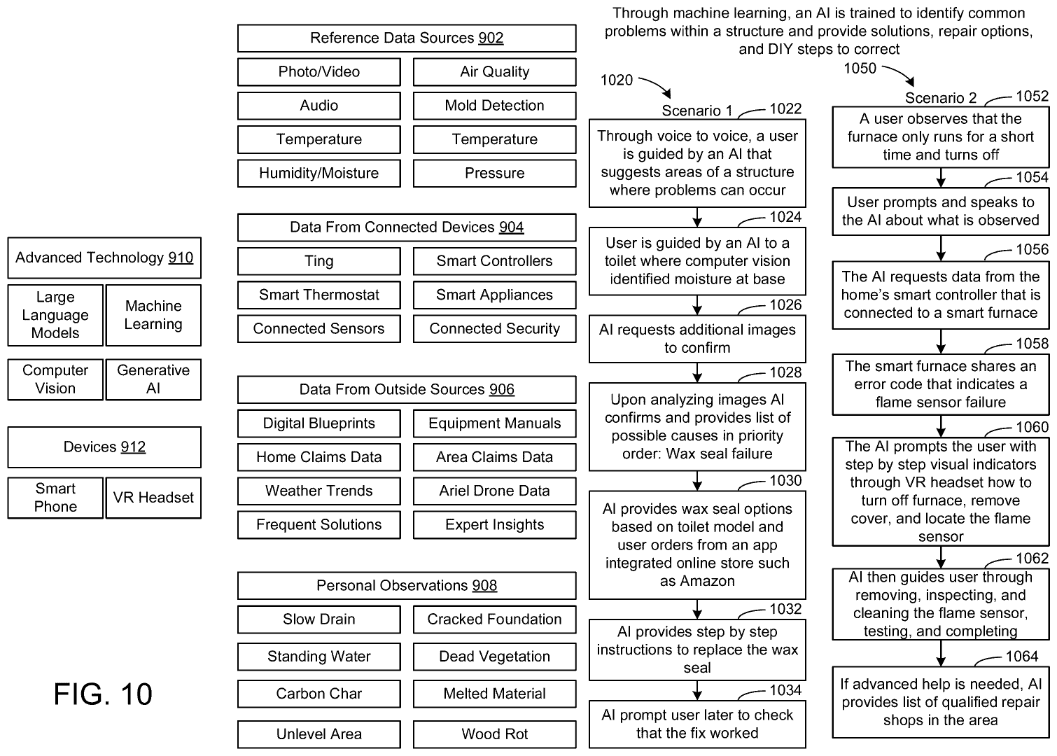

Referring now to FIG. 10, a block diagram of exemplary reference data sources used by the artificial intelligence assisted inspection system and exemplary use cases for resolving building faults based upon the building inspection report are shown, according to some embodiments. The block diagram of exemplary reference data sources includes the plurality of exemplary data sources 902-908 shown, according to some implementations. The exemplary data sources are described in greater detail with respect to FIG. 9. The plurality of advanced technologies 910 are shown, according to some embodiments. The advanced technology 910 described herein may be implemented on or using one or more devices 912, which are described in greater detail with respect to FIG. 9.

Referring still to FIG. 10, a computer-implemented or computer-based process, shown as process 1020, illustrating a first exemplary use case for using the AI-assisted application to determine faults in a building and generating repair recommendation to resolve the fault is shown, according to some embodiments. The process 1020 may be similar to the process 700 described with respect to FIG. 7 herein.

At block 1022, a user may be guided or instructed by an AI model on an inspection application. The AI model may use voice-to-voice capabilities to suggest, to the user, areas of a structure where problems may occur. For example, the AI model may be trained to suggest areas where problems have occurred in other structures.

At block 1024, the user may be guided by the AI model to a location where a problem may occur. In some embodiments, the user may be guided to a location identified to have a problem by, for example, computer vision. For example, the user may be guided, by the AI, to a toilet where moisture at the base of the toiler has been identified by using computer vision. At block 1026, the AI may send a prompt to the user (e.g., via the user device of the user) requesting additional images of the problem to confirm the problem. For example, the AI may request that the user upload additional images (e.g., at different angles) of the toilet.

At block 1028, the AI model may analyze the images uploaded by the user. The AI model may confirm the identified problem and may provide, to the user a list of possible causes of the problem. The list may be ordered based upon priority of the causes (e.g., the most important cause to address is listed first). For example, a cause of a toilet leaking at its base may be a wax seal failure.

At block 1030, based upon identifying a cause of the problem, the AI model may provide solutions related to the cause. For example, the AI model may provide wax seal options to address the wax seal failure of the toilet. The user may order an item relating to the solution from an application integrated online. For example, the user may order a wax seal from an online store. At block 1032, the AI model may provide step-by-step instructions to the user to perform the repair. For example, the AI model may provide step-by-step instructions to the user to replace the wax seal on the toilet. At block 1034, the AI model may prompt the user, after a predetermined period of time since the repair, to check and/or confirm that the repair was effective (e.g., the problem is resolved).

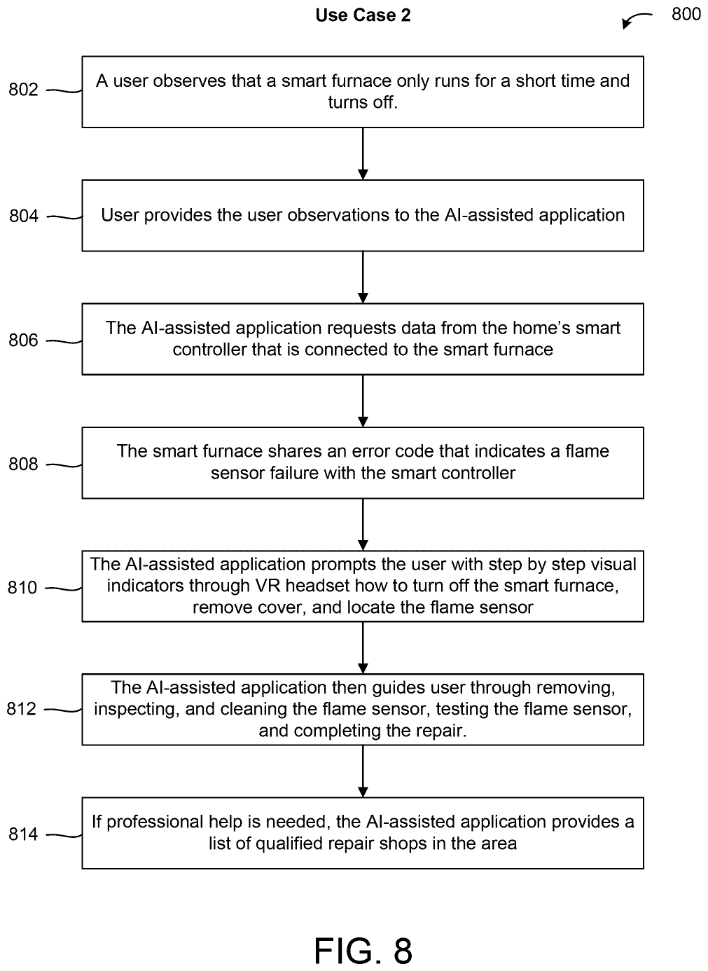

Referring still to FIG. 10, a computer-implemented or computer-based process, shown as process 1050, illustrating a second exemplary use case for using the AI-assisted application to determine faults in a building and generating repair recommendation to resolve the fault is shown, according to some embodiments. The process 1050 may be similar to the process 800 described with respect to FIG. 8 herein.

At block 1052, a user may observe that a furnace in a home runs for a short time and subsequently turns off. At block 1054, the user may prompt an AI model and communicate the observation to the AI model (e.g., by speaking into a user device having the AI model).

At block 1056, the AI model may request data from a smart controller of the home that is connected to the furnace. In various embodiments, the furnace may be a smart furnace. At block 1058, the furnace may share an error code with the AI model. The error code may be indicative of a flame sensor failure.

At block 1060, the AI model may prompt the user to repair the furnace. For example, the AI model may provide, to the user, via a VR headset or other device 1012, step-by-step visual indicators for accessing the component experiencing the error (e.g., the flame sensor). The step-by-step visual indicators may include, for example, steps indicating how to turn off the furnace, remove a cover of the furnace, and locate the flame sensor.

At block 1062, the AI model may guide the user, via the VR headset, through steps to repair the furnace. For example, the AI model mat guide the user through removing, inspecting, and cleaning the flame sensor. The AI model may also guide the user through testing the flame sensor to ensure the error has been resolved and completing the repair (e.g., replacing the cover of the furnace, turning the furnace back on, etc.). At block 1064, the AI model may determine that advanced help (e.g., a professional, a serviceperson, etc.) is needed to perform the repair. The AI model may provide a list of qualified repair shops proximate a location of the user.

### Exemplary Machine Learning and Generative AI

As discussed elsewhere, some implementations may utilize machine learning, generative artificial intelligence, or other advanced computing techniques. As such, in some embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in some embodiments, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, wearables, smart devices, smart glasses, smart rings, laptops, voice bots, chatbots, other input/output devices, and/or other image processing techniques discussed below. Additionally or alternatively, in some embodiments, the chatbot ML module may be configured and/or trained to implement one or more aspects of the machine vision, image recognition, objection identification, and/or other image processing techniques discussed below.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In some embodiments, the system is executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions may be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

1. A building inspection system for generating a structured building inspection report for at least a portion of a residential building, the building inspection system comprising:
one or more memory devices having instructions stored thereon that, when executed by one or more processors, cause the one or more processors to perform operations comprising:
receiving building data for the residential building from one or more data sources, wherein the building data includes structural information about the at least a portion of the residential building;
determining a layout for the at least a portion of the residential building based upon the structural information;
generating a guided building assessment plan on a user device based upon the building data, wherein the guided building assessment plan provides inspection instructions for a user to gather unstructured user observations of the at least a portion of the residential building;
receiving the unstructured user observations; and
automatically generating, using an artificial intelligence model, the structured building inspection report in a predetermined format for delivery to one or more users associated with the residential building based upon the building data and the unstructured user observations.

2. The building inspection system of claim 1, wherein the one or more data sources include at least one of a connected devices data source configured to provide data regarding one or more connected devices, a user device data source configured to provide data regarding a user device, a provider data source configured to provide data regarding a provider, a third party data source configured to provide data from one or more third parties, or an integrated software data source configured to provide data regarding integrated software associated with the residential building.

3. The building inspection system of claim 1, wherein the user device is at least one of a smart mobile device, a virtual reality device, or an augmented reality device.

4. The building inspection system of claim 1, wherein the guided building assessment plan is at least one of a room-by-room guided building assessment plan or a component-by-component guided building assessment plan.

5. The building inspection system of claim 1, wherein the inspection instructions include requesting at least one of images, natural language written observations, or natural language speech observations.

6. The building inspection system of claim 1, wherein automatically generating the structured building inspection report comprises:
receiving a first unstructured user observation from the user via a conversational chat bot associated with a large language model;
generating, by the large language model, a follow-up prompt requesting additional information about the first unstructured user observation;
in response to receiving the follow-up prompt, receiving a second unstructured user observation providing the additional information; and
processing, by one or more artificial intelligence (AI) models, the first unstructured user observation and the second unstructured user observation to generate the structured building inspection report.

7. The building inspection system of claim 6, wherein the one or more AI models include a generative AI model.

8. The building inspection system of claim 6, wherein the one or more AI models include a computer vision model.

9. The building inspection system of claim 1, wherein the structured building inspection report comprises a plurality of building faults, and wherein the instructions cause the one or more processors to automatically generate the structured building inspection report by determining priorities for the plurality of building faults and order the plurality of building faults within the structured building inspection report using the determined priorities.

10. The building inspection system of claim 1, wherein the operations further comprise generating a maintenance plan for the building based upon the structured building inspection report.

11. A computer-implemented method for generating a structured building inspection report for at least a portion of a building, the computer-implemented method comprising:
receiving, by one or more processors, building data for a building from one or more data sources, wherein the building data includes structural information about the at least a portion of the building;
determining, by the one or more processors, a layout for at least a portion of the building based upon the structural information;
generating, by the one or more processors, a guided building assessment plan on a user device based upon the building data, wherein the guided building assessment plan provides inspection instructions for a user to gather unstructured user observations of the at least portion of the residential building;
receiving the unstructured user observations; and
automatically generating, by the one or more processors and using an artificial intelligence model, the structured building inspection report in a predetermined format for delivery to one or more users associated with the building based upon the building data and the unstructured user observations.

12. The computer-implemented method of claim 11, wherein the one or more data sources include at least one of a connected devices data source configured to provide data regarding one or more data source, a user device data source configured to provide data regarding a user device, a provider data source configured to provide data regarding a provider, a third party data source configured to provide data from one or more third parties, or an integrated software data source configured to provide data regarding integrated software associated with the building.

13. The computer-implemented method of claim 11, wherein the user device is at least one of a smart mobile device, a virtual reality device, or an augmented reality device.

14. The computer-implemented method of claim 11, wherein the guided building assessment plan is at least one of a room-by-room guided building assessment plan or a component-by-component guided building assessment plan.

15. The computer-implemented method of claim 11, wherein the inspection instructions include requesting at least one of images, natural language written observations, or natural language speech observations.

16. The computer-implemented method of claim 11, wherein automatically generating the structured building inspection report comprises:
receiving, by the one or more processors, a first unstructured user observation from the user via a conversational chat bot associated with a large language model;
generating, by the one or more processors and using the large language model, a follow-up prompt requesting additional information about the first unstructured user observation;
in response to receiving the follow-up prompt, receiving, by the one or more processors, a second unstructured user observation providing the additional information; and
processing, by the one or more processors and using one or more artificial intelligence (AI) models, the first unstructured user observation and the second unstructured user observation to generate the structured building inspection report.

17. The computer-implemented method of claim 11, wherein the structured building inspection report comprises a plurality of building faults, and wherein the instructions cause the one or more processors to automatically generate the structured building inspection report by determining priorities for the plurality of building faults and order the plurality of building faults within the structured building inspection report using the determined priorities.

18. The computer-implemented method of claim 11, further comprising:
generating, by the one or more processors, a maintenance plan for the building based upon the structured building inspection report.

19. A non-transitory computer readable medium comprising instructions stored thereon that, when executed by one or more processors, cause the one or more processors to perform operations comprising:
receiving one or more unstructured user observations from a user regarding at least one of a component or a space of a residential building;
processing, using one or more artificial intelligence (AI) models, the one or more unstructured user observations to identify one or more additional data items regarding the at least one of the component or the space;
obtaining the one or more additional data items;
determining, by the one or more AI models using the one or more unstructured user observations and the one or more additional data items, a building fault associated with the at least one of the component or the space of the residential building and a type of repair to resolve the building fault; and
initiating, using the one or more AI models, an automatic action to resolve the building fault based upon the determined type of repair.

20. The non-transitory computer readable medium of claim 19, wherein the operations further comprise:
in response to determining the type of repair is a non-professional repair, automatically generating step-by-step instructions for a non-professional user to resolve the building fault; and
in response to determining the type of repair is a professional repair, automatically scheduling a service appoint for professional maintenance personnel to resolve the building fault.
